(19) United States
(12) Patent Application Publication
(10) Pub. No.: US 2016/0207449 A1
(43) Pub. Date: Jul. 21, 2016

(54) U-Turn Signaling Device

(71) Applicants: Robert Noble, Carlsbad, CA (US); Chauncy Noble, Carlsbad, CA (US); Gerald Scott Parker, Saddle River, NJ (US); Frank Anthony Calabrese, Monroe, CT (US)

(72) Inventors: Robert Noble, Carlsbad, CA (US); Chauncy Noble, Carlsbad, CA (US); Gerald Scott Parker, Saddle River, NJ (US); Frank Anthony Calabrese, Monroe, CT (US)

(21) Appl. No.: 14/987,195

(22) Filed: Jan. 4, 2016

Related U.S. Application Data
(60) Provisional application No. 62/105,824, filed on Jan. 21, 2015.

(51) Int. Cl. B60Q 1/34

(52) U.S. Cl. CPC B60Q 1/34

(57) ABSTRACT

A U-turn signaling device for a vehicle for signaling that the driver is going to or is currently performing a U-turn. The U-turn signaling device includes a headlight assembly and a taillight assembly, wherein each light assembly includes a U-shaped light therein. A control circuit includes an activation device, a microprocessor, and the U-shaped lights of the light assemblies. Depending upon the embodiment, the activation device may be used to selectively or automatically illuminate the U-shaped lights so as to indicate to other drivers that the driver is performing a U-turn.

### CROSS REFERENCE TO RELATED APPLICATION

This application claims the benefit of U.S. Provisional Application No. 62/105,824 filed on Jan. 21, 2015. The above identified patent application is herein incorporated by reference in its entirety to provide continuity of disclosure.

### BACKGROUND OF THE INVENTION

### Field of the Invention

The present invention relates to vehicle signaling devices. More specifically, the present invention provides a U-turn signaling device for automobiles in order to improve communication and signaling among drivers on public roadways.

Vehicles include various indicator lights for signaling a driver's actions to other drivers. This helps to provide notice to other vehicles in order to prevent collisions or accidents. Common signal lights, such as brake lights, indicate to other drivers that the vehicle is slowing down. Turn signals indicate to other drivers that the vehicle will turn onto another street or roadway, or that the driver is planning to change lanes on a highway. Thus, the signal lights allow drivers to communicate their actions to others in the nearby area.

However, not all actions can be signaled using conventional signal lights. Notably, a driver is unable to indicate to other drivers if he or she is planning on making a U-turn. Typically, the driver activates a left or right turn signal when performing a U-turn, but this type of signaling does not accurately indicate the driver's planned course of action. As a result, a driver cannot properly indicate when he or she is making a U-turn which can create confusion among other drivers in the nearby area. Thus, a U-turn signaling device for automobiles is desired.

Devices have been disclosed in the prior art that relate to vehicle signaling devices. These include devices that have been patented and published in patent application publications. These devices generally relate to U-turn signaling devices, such as U.S. Patent Publication Number 2014/0091920, U.S. Pat. No. 8,519,840, U.S. Patent Publication Number 2007/0069881, U.S. Pat. No. 6,958,687, and U.S. Pat. No. 4,994,786.

These prior art devices have several known drawbacks. The devices in the prior art fail to provide a U-turn signaling device that can be automatically activated via a GPS unit or via voice activation. Further, such devices fail to provide headlight and taillight assemblies each having a U-shaped light therein adapted to indicate that the user is performing a U-turn.

In light of the devices disclosed in the prior art, it is submitted that the present invention substantially diverges in design elements from the prior art and consequently it is clear that there is a need in the art for an improvement to existing vehicle signaling devices. In this regard the instant invention substantially fulfills these needs.

### SUMMARY OF THE INVENTION

In view of the foregoing disadvantages inherent in the known types of vehicle signaling devices now present in the prior art, the present invention provides a new vehicle signaling device wherein the same can be utilized for providing convenience for the user when notifying other drivers that he or she anticipates performing a U-turn.

The U-turn signaling device comprises a headlight assembly and a taillight assembly, wherein each vehicle light assembly includes a U-shaped light therein. The U-shaped lights are part of a control circuit that enables the user to selectively activate the U-shaped lights. The U-shaped lights are adapted to illuminate when the user is performing a U-turn. The lights may be manually activated via a dedicated control disposed within the interior of the vehicle. Alternatively, the lights may be activated when the steering wheel is turned a predetermined extent or when a GPS unit detects that the vehicle is performing a U-turn.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the front of a vehicle having the U-turn signaling device.

FIG. 2 shows a perspective view of the rear of a vehicle having the U-turn signaling device.

FIG. 3 shows a schematic diagram of the U-turn signaling device.

### DETAILED DESCRIPTION OF THE INVENTION

Reference is made herein to the attached drawings. Like reference numerals are used throughout the drawings to depict like or similar elements of the U-turn signaling device. For the purposes of presenting a brief and clear description of the present invention, the preferred embodiment will be discussed as used for signaling that the driver anticipates performing or is performing a U-turn. The figures are intended for representative purposes only and should not be considered to be limiting in any respect.

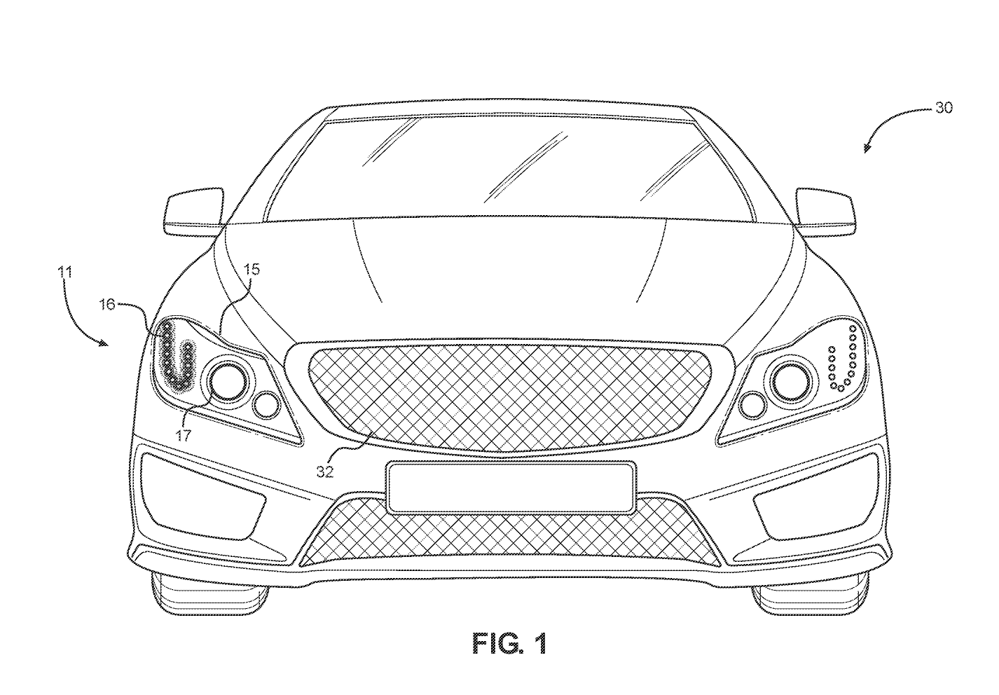

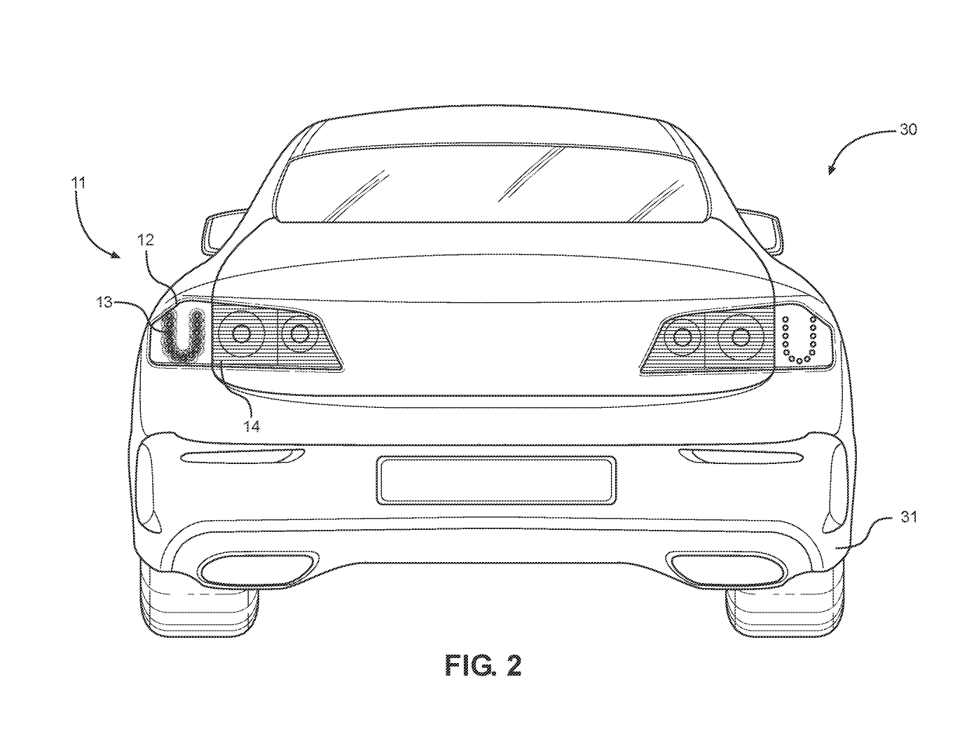

Referring now to FIGS. 1 and 2, there are shown front and rear views of a vehicle having the U-turn signaling device. The U-turn signaling device 11 comprises a headlight assembly 15 adapted to be installed on the front end 32 of a vehicle 30. The U-turn signaling device 11 can be used with any of various types of automobiles including cars, pick-up trucks, SUVs, vans, and tractor trailers, among others. The headlight assembly 15 is mounted on the front 32 of a vehicle 30 in the traditional fashion, and includes one or more lights 17 therein. The headlight assembly 15 is constructed similarly to traditional headlight assemblies and includes high and low beams, fog lights, and turn signal lights. The headlight assembly 15 further comprises a U-shaped light 16 therein. Preferably, a U-shaped light 16 is positioned within the headlight assembly 15 of both the left headlight and the right headlight of the vehicle 30. The U-shaped light 16 is preferably disposed at an angle within the headlight assembly 15 so that the U-shaped light 16 is visible to drivers facing the side of the user's vehicle. For this reason, the U-shaped light 16 is preferably positioned on an outer portion of the headlight assembly 15. This allows drivers traveling perpendicularly to the user to view the U-shaped light 16 so that the drivers can determine if the user is performing a U-turn.

Similarly, a rear taillight assembly 12 is provided and resembles traditional rear taillights. The rear taillight assembly 12 comprises one or more lights 14 therein for indicating conventional signals, such as brake lights and turn signal lights. The rear taillight assembly 12 further comprises a U-shaped light 13 therein. Preferably, both the left and right taillight assemblies 12 include U-shaped lights 13 therein. In this way, other drivers are alerted as to whether the driver will be initiating a U-turn to the left or to the right.

In alternate embodiments, a full headlight assembly 15 and taillight assembly 12 are not required and a U-shaped light 13, 16 can be retrofitted into existing headlight and taillight assemblies. In this way, vehicles manufactured without the U-shaped lights 13, 16 can be retrofitted so as to have the U-shaped lights 13, 16 therein. The U-shaped lights 13, 16 are adapted to be electrically connected to the vehicle's existing electrical system via one or more electrical cables and other necessary circuit components and are powered via the vehicle's battery. It is not desired to limit the specific manner in which the U-shaped lights are electrically connected to the vehicle's electrical system.

Each U-shaped light 13, 16 comprises one or more light sources. In the illustrated embodiment, the U-shaped light 13, 16 is composed of a plurality of light sources. Preferably, the plurality of light sources include LEDs. The U-shaped lights 13, 16 are preferably positioned adjacent to the conventional signaling lights in the headlight and taillight assemblies. However, it is not desired to limit the exact positioning of the U-shaped light within the headlight and taillight assemblies.

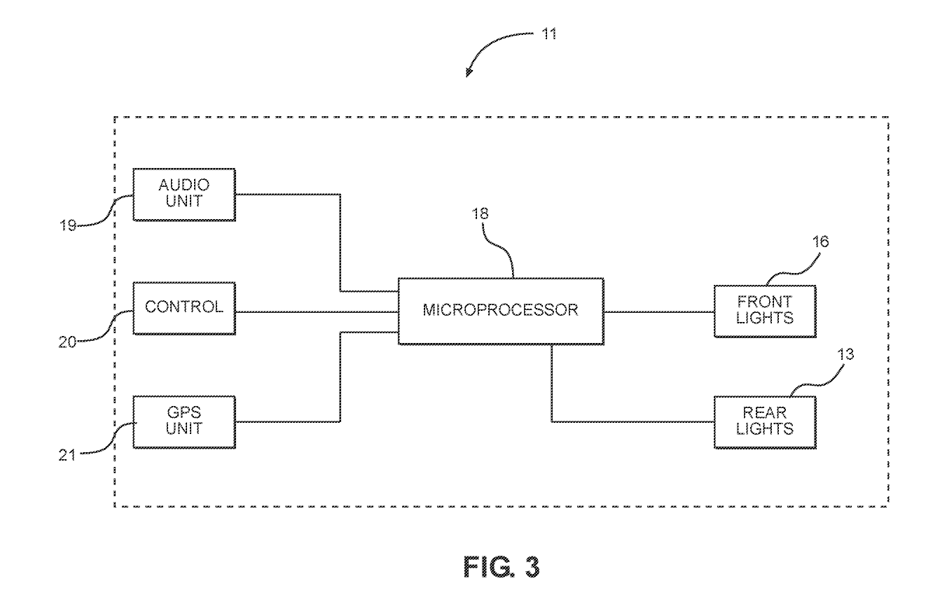

Referring now to FIG. 3, there is shown a schematic diagram of the U-turn signaling device. A control circuit allows the U-shaped lights to be automatically or selectively actuated, depending upon the embodiment. The control circuit comprises an activation device, a microprocessor 18, and a plurality of U-shaped lights 13, 16. The control circuit is preferably powered via the vehicle's electrical system and battery. In operation, when the activation device is triggered, the control circuit causes the U-shaped lights 13, 16 to temporarily illuminate.

In some embodiments, the activation device comprises a dedicated control 20 disposed within the vehicle. The control 20 is a push button, toggle switch, a lever, or other similar control that can be actuated by the user. The user can actuate the control 20 in order to indicate to other drivers that he or she will be performing a U-turn. Preferably, the control allows the user to select whether he or she will be performing a U-turn to his or her left or right. When the control 20 is actuated, the U-shaped lights on the corresponding side of the vehicle are illuminated. Preferably, the U-shaped lights are illuminated constantly. However, in alternate embodiments the U-shaped lights may flash on and off during the U-turn. The U-shaped lights are adapted to cease illumination once the U-turn is complete.

In alternate embodiments, the activation device comprises an audio unit 19. The audio unit 19 is adapted to be positioned within the interior of the vehicle and is configured to detect a user's voice. The audio unit preferably comprises a microprocessor, a storage medium, and a microphone, wherein the microphone detects the user's voice and compares the user's spoken words to a predetermined activation word or phrase. If the words spoken by the user correspond to the predetermined activation word or phrase, the U-shaped lights are activated. The audio unit may further include a display for indicating whether the user's voice has been accurately recognized or whether the user has failed to state the correct activation word. The lights are activated for a predetermined period of time and then cease illumination. Alternatively, the U-shaped lights may be illuminated throughout the duration of the turn and then cease to illuminate once the U-turn has been completed as determined by the positioning of the steering wheel.

In an alternate embodiment, the activation device comprises a GPS unit 21 that is adapted to detect the position of the vehicle. In this embodiment, the GPS unit determines the position of the vehicle and can thus determine if the vehicle is turning. If the vehicle turns greater than 90 degrees, the microprocessor will determine from the GPS data that the vehicle is performing a U-turn. Once the GPS unit 21 determines that the driver is performing a U-turn as determined by the movement of the vehicle, the control circuit illuminates the U-shaped lights 13, 16. In this way, the U-shaped lights automatically illuminate and cease illumination without input from the user.

In further embodiments, the activation device includes a sensor adapted to detect the extent to which the steering wheel has been turned. Preferably, the sensor is operably connected to the steering wheel so as to determine the position and/or rotation of the steering wheel. In order to perform a U-turn, the steering wheel must be rotated sharply. Thus, if the sensor detects that the steering wheel has been rotated to a predetermined degree, the control circuit causes the U-shaped lights 13, 16 to be activated. Once the steering wheel returns to its original resting position, the U-shaped lights are deactivated. In this way, the U-shaped lights automatically activate and deactivate without requiring the user's input.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A U-turn signaling device, comprising:
a headlight assembly comprising a U-shaped light;
a control circuit comprising a microprocessor, the U-shaped light of the headlight assembly, and an activation device, wherein the activation device is adapted to illuminate the U-shaped light so as to indicate that a user is performing a U-turn.

2) The U-turn signaling device of claim 1, further comprising a taillight assembly comprising a U-shaped light, wherein the control circuit further comprises the U-shaped light of the taillight assembly.

3) The U-turn signaling device of claim 1, wherein the activation device comprises a GPS unit adapted to detect the movement of the vehicle so as to determine if the vehicle is making a U-turn.

4) The U-turn signaling device of claim 1, wherein the activation device comprises a sensor adapted to determine the extent to which the steering wheel has been rotated, wherein the U-shaped lights are activated when the steering wheel has been rotated a predetermined extent.

5) The U-turn signaling device of claim 1, wherein the activation device comprises a control adapted to be actuated by the user in order to activate the U-shaped lights.

6) The U-turn signaling device of claim 1, wherein the activation device comprises an audio unit adapted to activate the U-shaped lights when the user speaks an activation word.

7) The U-turn signaling device of claim 1, wherein the U-shaped light comprises a plurality of light sources.

8) The U-turn signaling device of claim 1, wherein the U-shaped light is adapted to provide constant illumination when activated.
